(19) United States
(12) Patent Application Publication
(10) Pub. No.: US 2017/0121485 A1
(43) Pub. Date: May 4, 2017

(54) Method for Coating a Substrate

(71) Applicant: ContiTech Elastomer-Beschichtungen GmbH, Hannover (DE)

(72) Inventors: Thomas Moldenhauer, Northeim (DE); Sabine Luther, Hannover (DE); Thomas Perkovic, Bovenden (DE); Heiko Eymer, Northeim (DE)

(73) Assignee: ContiTech Elastomer-Beschichtungen GmbH, Hannover (DE)

(21) Appl. No.: 15/116,233

(22) PCT Filed: Jan. 9, 2015
(86) PCT No.: PCT/EP2015/050288

§ 371 Date: Nov. 11, 2016

(30) Foreign Application Priority Data
Feb. 18, 2014 (DE) 10 2014 202 965.1

(51) Int. Cl. C08J 9/32; C09D 5/00; C09D 201/00; B41N 10/02; B05D 3/02; B29C 43/24; B29C 44/32; C08J 9/06; B05D 1/26

(52) U.S. Cl. CPC C08J 9/32; C08J 9/06; C09D 5/00; C09D 201/00; B05D 1/265; B05D 3/0263; B29C 43/24; B29C 44/321; B41N 10/02; C08J 2300/26; C08J 2203/22; C08J 2201/02; B29K 2021/00

(57) ABSTRACT

A process for the coating a substrate with a microporous layer includes at least incorporation by mixing of at least one physical and/or chemical blowing agent into an elastomer mixture, shaping of the elastomer mixture including the physical and/or chemical blowing agent by means of a calender or of a roller-head system, and application of the calendered elastomer mixture including the physical and/or chemical blowing agent to a substrate to be coated. Further, heating and blowing of the coating including the physical and/or chemical blowing agent is then provided by means of at least one heat source. In some cases, the blowing agent is composed of microspheres, which in some embodiments, may be present in non-expanded form. In some aspects, the heating and blowing of the coating directly follows the application procedure. The heat source may be an infrared source, such as a ceramic source.

### CROSS REFERENCE TO RELATED APPLICATIONS

This application is a continuation application of international patent application PCT/EP2015/050288, filed Jan. 9, 2015, designating the United States and claiming priority from German patent application 10 2014 202 965.1, filed Feb. 18, 2014, and the entire content of these applications is incorporated herein by reference.

### FIELD

The disclosure relates to a process for the coating of a substrate.

### BACKGROUND

This section provides background information to facilitate a better understanding of the various aspects of the disclosure. It should be understood that the statements in this section of this document are to be read in this light, and not as admissions of prior art.

In the field of printing blankets, the compressible layer of the printing blanket mostly takes the form of a microporous layer. Production of a printing blanket with a compressible layer is described by way of example in DE 10 2010 036 717 A1. The microporous compressible layer here is formed by means of heated rolls.

Microspheres are often used to form the microporous layer. By way of example DE-A 2 117 892 proposes microspheres for the use in the compressible layer of rubber printing blankets. Hollow, thermoplastic microspheres can be used here either in pre-expanded form or in expandable form. A process proposed in DE-A 2 117 892 and often used for the introduction of the microspheres into the rubber polymer consists in dispersion of the microspheres in a rubber mixture solution made of rubber mixture and organic solvent. This solution is then cast or distributed (doctor process) to give a layer of desired thickness, dried, and vulcanized. The solution here can be directly cast onto other layers of the printing blanket, or distributed thereon, for example on a reinforcing layer made of a textile. The process involves solvent, and therefore gives rise to environmental concerns. It is moreover energy-intensive and costly, because a rubber mixture solution first has to be produced, and then the solvent has to be driven off after the distribution procedure, before vulcanization. Pre-expanded microspheres are generally used here.

EP 2 275 475 B1 describes a process for the production of a rubber mixture for printing blankets where the microspheres in pre-expanded form are first mixed with a plasticizer oil before they are introduced into the rubber mixture. Damage to the microspheres by the shear forces in the mixing process is thus reduced.

It is likewise possible to use non-expanded microspheres. In this case either the layer comprising the microspheres or the entire final product in a laminate then has to be subjected to a blowing process in order that the microspheres can expand and the desired porous structure can thus form. The blowing process mostly takes place in a closed vessel, and this requires complicated machine design, is energy-intensive, and moreover is also costly.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

Some embodiments of the disclosure are based on the object of providing a process which can be carried out in a manner that is simple and comparatively inexpensive, and does not give rise to environmental concerns, for the coating of a substrate in order to obtain a microporous layer.

In some embodiments, a process for the coating a substrate with a microporous layer is provided which includes at least incorporation by mixing of at least one physical and/or chemical blowing agent into an elastomer mixture, shaping of the elastomer mixture including the physical and/or chemical blowing agent by means of a calender or of a roller-head system, and application of the calendered elastomer mixture including the physical and/or chemical blowing agent to a substrate to be coated. Further, heating and blowing of the coating including the physical and/or chemical blowing agent is then provided by means of at least one heat source. In some cases, the blowing agent is composed of microspheres, which in some embodiments, may be present in non-expanded form. In some aspects, the heating and blowing of the coating directly follows the application procedure. The heat source may be an infrared source, and in some embodiments, the infrared source is a ceramic source.

In some embodiments, the process is used for production of a coated substrate which is a compressible rubber layer. The coated substrate may also be covered with one or more textile layers and/or further rubber mixture layers. In some cases, the coated substrate is a printing blanket.

### BRIEF DESCRIPTION OF THE DRAWINGS

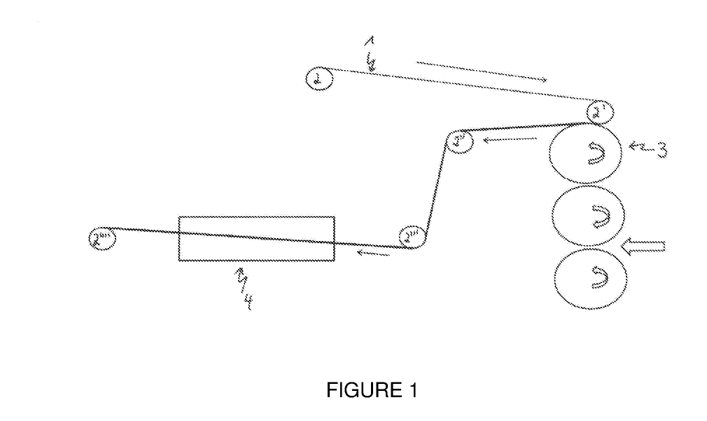

Certain embodiments of the disclosure will hereafter be described with reference to the accompanying drawings, wherein like reference numerals denote like elements. It should be understood, however, that the accompanying figures illustrate the various implementations described herein and are not meant to limit the scope of various technologies described herein, and FIG. 1 is a diagram of a process according to the disclosure.

### DETAILED DESCRIPTION

The following description of the variations is merely illustrative in nature and is in no way intended to limit the scope of the disclosure, its application, or uses. The description and examples are presented herein solely for the purpose of illustrating the various embodiments of the disclosure and should not be construed as a limitation to the scope and applicability of the disclosure. In the summary of the disclosure and this detailed description, each numerical value should be read once as modified by the term “about” (unless already expressly so modified), and then read again as not so modified unless otherwise indicated in context. Also, in the summary of the disclosure and this detailed description, it should be understood that a value range described as being useful, suitable, or the like, is intended that any and every value within the range, including the end points, is to be considered as having been stated. For example, “a range of from 1 to 10” is to be read as indicating each and every possible value along the continuum between about 1 and about 10. Thus, even if specific data points within the range, or even no data points within the range, are explicitly identified or refer to only a few specific, it is to be understood that inventors appreciate and understand that any and all data points within the range are to be considered to have been specified, and that inventors had possession of the entire range and all value within the range.

Unless expressly stated to the contrary, “or” refers to an inclusive or and not to an exclusive or. For example, a condition A or B is satisfied by anyone of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of concepts according to the disclosure. This description should be read to include one or at least one and the singular also includes the plural unless otherwise stated.

The terminology and phraseology used herein is for descriptive purposes and should not be construed as limiting in scope. Language such as “including,” “comprising,” “having,” “containing,” or “involving,” and variations thereof, is intended to be broad and encompass the subject matter listed thereafter, equivalents, and additional subject matter not recited.

Also, as used herein any references to “one embodiment” or “an embodiment” means that a particular element, feature, structure, or characteristic described in connection with the embodiment is included in at least one embodiment. The appearances of the phrase “in one embodiment” in various places in the specification are not necessarily referring to the same embodiment.

Embodiments of the disclosure are based on the object of providing a process which can be carried out in a manner that is simple and comparatively inexpensive, and does not give rise to environmental concerns, for the coating of a substrate in order to obtain a microporous layer. At the same time, the intention is to permit effective setting of the thickness of the substrate inclusive of the coating, i.e. setting without major variations. The said object is achieved according to the disclosure in a process including at least the following steps:
in a first step, incorporation by mixing of at least one physical and/or chemical blowing agent into an elastomer mixture, and
in at least one further step, shaping of the elastomer mixture including the physical and/or chemical blowing agent by means of a calender or of a roller-head system, and
in at least one further step, application of the calendered elastomer mixture including the physical and/or chemical blowing agent to a substrate to be coated, and
in a further step, heating and blowing of the coating including the physical and/or chemical blowing agent by means of at least one heat source.

Surprisingly, it has been found that the combination of calendering and heating by means of at least one heat source permits effective adjustment of the blowing behaviour of the blowing agent used. Said adjustment is achieved by way of the temperature of the heat source and by way of the calender settings.

In subsequent operations, for example for the use in a printing blanket, it is generally necessary to combine the blown elastomer layer with further substrates. This now becomes possible without further intermediate heating because it is possible to achieve effective adjustment of the thickness of the blown elastomer layer. Separate provision of an adhesive layer to the as yet unvulcanized surface is therefore no longer necessary; instead, said surface can be covered directly. This provides not only the saving of adhesive layers but also an additional logistical advantage. Unlike the previously known spread-application of the elastomer layer including blowing agents, in particular the microspheres, which mostly requires a solution mixer, spreading machinery, and vessels, the invention merely requires a calender. This eliminates the need for a number of devices that have complicated technical operating requirements.

In some aspects, the heating and blowing of the coating directly follows the application procedure, i.e. takes place during the sheet-formation procedure. Sheet-formation means the calender-shaping of the elastomer mixture is directly followed by the application of this layer to a concurrent substrate, where the concurrent substrate is preferably a textile web, a foil, a metal sheet, or any other type of web material.

The application procedure is, in some cases, achieved by using a calender or a roller-head system.

The term blowing agents usually means pore-forming blowing gases, e.g. azo compounds and diazo compounds which evolve gases (e.g. N₂ or CO₂) under the influence of heat or catalysts, and therefore serve for the production of foamed polymer mixtures. Chemical blowing agents of these types decompose at a certain temperature during processing with evolution of gas, or in the case of addition of volatile solvents during polymerization or vulcanization.

Physical blowing agents often used are microspheres. These can be used in expanded form or in non-expanded form. They are, in some aspects, non-expanded microspheres which take the form of hollow microspheres made of glass, phenolic resin or carbon. However, it is also possible to use microspheres made of thermoplastic material. These, in some cases, have certain resilience and are more successful in withstanding the shear forces during the mixing process and during calendering.

In some aspects, it is preferable that the thermoplastic material is at least one acrylonitrile polymer. Hollow microspheres of these types are obtainable inter alia as Expancel® from Akzo Nobel.

The quantity of the microspheres of the elastomer layer is from 0.5 to 10% by mass in some cases, or even from 1 to 5% by mass.

The heat source used can be any of the known heat sources, for example an oven supplied with heated air. However, in some aspects, the heat source is an infrared source (IR source), such as a ceramic source.

In a ceramic source the ceramic elements are heated indirectly by metallic heating coils. The ceramic elements are preferably square or rectangular. These allow very effective placing adjacent to the desired areas, thus permitting achievement of a homogeneous radiant field and thus a homogeneous temperature field.

The devices known as quartz sources can likewise be used as alternative, these being similar to a lamp. However, these permit only a tubular arrangement.

The surface temperature of the ceramic sources may be from 300 to 500° C., and they radiate over a wide range in the wavelength range from 2 to 10 μm. This leads to surface temperatures of the coated substrate of from 180 to 190° C. At this temperature the entire layer thickness of the coated substrate undergoes expansion. In some cases, the thickness of the elastomer layer is from 0.1 mm to 1 mm. The expansion index may be from 50 to 150%.

The substrate coated by the processes according to the disclosure may be used for the production of a compressible rubber layer. By way of example it is possible to produce thin foam rubber layers or compressible rubber layers of printing blankets in a manner that is simple and does not give rise to environmental concerns.

The following described figure will be used for further explanation of some embodiments of the disclosure, but embodiments are not necessarily restricted thereto. FIG. 1 is a diagram of a process according to the disclosure. The substrate 1 to be coated is unwound from a roller 2, and in the context of a sheet-formation process the elastomer mixture comprising the physical and/or chemical blowing agent is applied by way of a calender 3. After the substrate, now coated, has been further passed over various rollers 2″, 2′″, the blowing agent is expanded by means of a heat source 4, such as by means of infrared sources. The expanded and coated substrate is then wound up by means of a further roller 2″″, and is available for further processing, in particular for production of a printing blanket.

Key (Part of the Description)

1 Substrate

2, 2′, 2″, 2′″, 2″″ Roller

3 Calender

4 Heat source

The foregoing description of the embodiments has been provided for purposes of illustration and description. Example embodiments are provided so that this disclosure will be sufficiently thorough, and will convey the scope to those who are skilled in the art. Numerous specific details are set forth such as examples of specific components, devices, and methods, to provide a thorough understanding of embodiments of the disclosure, but are not intended to be exhaustive or to limit the disclosure. It will be appreciated that it is within the scope of the disclosure that individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

Also, in some example embodiments, well-known processes, well-known device structures, and well-known technologies are not described in detail. Further, it will be readily apparent to those of skill in the art that in the design, manufacture, and operation of apparatus to achieve that described in the disclosure, variations in apparatus design, construction, condition, erosion of components, gaps between components may present, for example.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner”, “adjacent”, “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

Although a few embodiments of the disclosure have been described in detail above, those of ordinary skill in the art will readily appreciate that many modifications are possible without materially departing from the teachings of this disclosure. Accordingly, such modifications are intended to be included within the scope of this disclosure as defined in the claims.

1-9. (canceled)

10. A process for coating of a substrate comprising a microporous layer, the process comprising:
in a first step, incorporation by mixing of at least one physical blowing agent into an elastomer mixture;
in at least one further step, shaping of the elastomer mixture comprising the physical blowing agent by means of a calender or of a roller-head system;
in at least one further step, application of the calendered elastomer mixture comprising the physical blowing agent to a substrate to be coated; and
in a further step, heating and blowing of the coating comprising the physical blowing agent by means of at least one heat source.

11. The process as claimed in claim 10, wherein the blowing agent is composed of microspheres.

12. The process as claimed in claim 11, wherein the microspheres are present in non-expanded form.

13. The process as claimed in claim 10, wherein the heating and blowing of the coating directly follows the application procedure.

14. The process as claimed in claim 10, wherein the heat source is an infrared source.

15. The process as claimed in claim 14, wherein the infrared source is a ceramic source.

16. The use, for production of a compressible rubber layer, of a substrate coated as claimed in claim 10.

17. The use as claimed in claim 16, wherein the coated substrate is covered with one or more textile layers and/or further rubber mixture layers.

18. The use as claimed in claim 16, as used for the production of a printing blanket

19. A process for coating of a substrate comprising a microporous layer, the process comprising:
in a first step, incorporation by mixing of at least one chemical blowing agent into an elastomer mixture;
in at least one further step, shaping of the elastomer mixture comprising the chemical blowing agent by means of a calender or of a roller-head system;
in at least one further step, application of the calendered elastomer mixture comprising the chemical blowing agent to a substrate to be coated; and
in a further step, heating and blowing of the coating comprising the chemical blowing agent by means of at least one heat source.

20. The process as claimed in claim 19, wherein the heating and blowing of the coating directly follows the application procedure.

21. The process as claimed in claim 19, wherein the heat source is an infrared source.

22. The process as claimed in claim 21, wherein the infrared source is a ceramic source.

23. The use, for production of a compressible rubber layer, of a substrate coated as claimed in claim 19.

24. The use as claimed in claim 23, wherein the coated substrate is covered with one or more textile layers and/or further rubber mixture layers.

25. The use as claimed in claim 24, as used for the production of a printing blanket

26. A process for coating of a substrate comprising a microporous layer, the process comprising:
in a first step, incorporation by mixing of at least one of a physical and a chemical blowing agent into an elastomer mixture;
in at least one further step, shaping of the elastomer mixture comprising the physical blowing agent and the chemical blowing agent by means of a calender or of a roller-head system;
in at least one further step, application of the calendered elastomer mixture comprising the physical blowing agent and the chemical blowing agent to a substrate to be coated; and
in a further step, heating and blowing of the coating comprising the physical blowing agent and the chemical blowing agent by means of at least one heat source.

27. The process as claimed in claim 26, wherein the physical blowing agent is composed of microspheres.

28. The process as claimed in claim 27, wherein the microspheres are present in non-expanded form.

29. The process as claimed in claim 26, wherein the heat source is an infrared source.
